(19) United States
(12) Patent Application Publication
(10) Pub. No.: US 2022/0047122 A1
(43) Pub. Date: Feb. 17, 2022

(54) Dental Care Timer

(71) Applicant: Rickie Hunt, Myrtle Creek, OR (US)

(72) Inventor: Rickie Hunt, Myrtle Creek, OR (US)

(21) Appl. No.: 17/166,287

(22) Filed: Feb. 3, 2021

Related U.S. Application Data
(60) Provisional application No. 63/066,258, filed on Aug. 16, 2020.

(51) Int. Cl. A47K 1/09; A61C 19/00; G04G 17/08; G04F 1/00

(52) U.S. Cl. CPC A47K 1/09; G04F 1/005; G04G 17/08; A61C 19/00

(57) ABSTRACT

This present invention relates to a dental care timer that informs both children and adults to brush their teeth for a minimum period of time, preferably two minutes. The dental care timer is preferably comprised of a stylish housing with a mounting or supporting structure. The front of the housing features a display for a countdown timer, a power button, and a speaker. An internal battery powers the dental care timer and its various components, and the timer device is capable of communicating with a user's smart device, such as a smart phone, smart watch, tablet or the like. Upon the conclusion of an appropriate brushing session, the dental care timer will emit an audible signal to the user.

### CROSS-REFERENCE TO RELATED APPLICATION

The present application claims priority to, and the benefit of, U.S. Provisional Application No. 63/066,258, which was filed on Aug. 16, 2020 and is incorporated herein by reference in its entirety.

### FIELD OF THE INVENTION

The present invention relates generally to the field of timing devices, such as alarm clocks. More specifically, the present invention relates to a two-minute alert system for brushing teeth, thereby ensuring people brush their teeth for a full allotted two-minute time period. The timing device or alert system features components, such as a human readable display, a power button and a speaker. The various components work in conjunction to display a two-minute countdown, and sound an alert or audible tone when the time period has elapsed. The alert system or timing device further comprises a durable adhesive on its backside to enable a user to mount the alert system on a wall or other surface. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, patients suffering from oral diseases and conditions account for the second largest domestic medical expenditure. Oral diseases and conditions include, but are not limited to, dental erosion, periodontal disease, bad breath, plaque build-up, gum disease, cavities and the like. Good oral health routines are important to maintain proper care of teeth and gums. Proper oral care routines such as twice daily brushing and flossing, using recommended brushes and toothpaste, rinsing with mouthwash and seeing a dentist regularly as suggested by dental experts are all part of a normal, healthy dental routine.

Brushing one's teeth helps to remove food, plaque and other materials that build-up over time. This material is a sticky white film that forms on the teeth and contains bacteria. For example, after eating a meal or snack that contains sugar, the bacteria in the plaque produces acids that attack tooth enamel. Eventually, if not treated, the acid can break down tooth enamel, causing cavities. Plaque that isn't removed can also harden into tartar, making it harder to keep teeth clean and requiring tools to scrape the tartar, as well as drills and water jets. Tartar buildup on the gums of a user can lead to inflammation that causes gum disease. Therefore, brushing of the teeth is a crucial part of the daily dental care routine of the user.

Current recommendations from the American Dental Association (ADA) encourage brushing for at least two minutes, twice per day. Spending less than two minutes brushing won't remove as much plaque or other build-up from the teeth. Both adults and/or children may not brush their teeth for the recommended two minutes if they are conscientiously aware of the time remaining, thereby leaving plaque on the teeth.

Therefore, there exists a long felt need in the art for a timing device that enables a user to brush their teeth for at least two minutes, is convenient to use and specifically relates to the task of brushing. There is also a long felt need in the art for an alarm device that allows a user to see the remaining time left for a proper brushing session, thereby promoting good oral health of the user. Additionally, there is a long felt need in the art for an alarm device that may be conveniently and securely attached to a surface near the brushing station or sink. Finally, there is a long felt need in the art for a two-minute alarm device which is relatively inexpensive to manufacture, and that is both safe and easy to use.

Generally stated, the subject matter disclosed and claimed herein, in one embodiment thereof, comprises an alert system for reminding adults and children alike to brush their teeth for a minimum of two minutes. The alert system comprises a housing having a generally octagonal shape, a timer contained therein, and an adhesive backing. The front of the housing further comprises a digital two-minute countdown timer, a power button, and a speaker. The alert device system is powered by an internal battery that may be a disposable battery or a rechargeable battery, and the durable adhesive on the backside of the alert system can be utilized to mount the system on a wall or other convenient location.

In use, the user can activate the alert or timing device by using the power button, thereby triggering the clock to begin a two-minute countdown on the display. Once the timer completes the timing cycle, a trumpet-style alert (or other user selectable audible sound) is emitted through the speaker to notify the user that the two-minute brushing sequence is completed, and the user may stop brushing his or her teeth. In this manner, the novel two-minute dental care timer of the present invention accomplishes all of the forgoing objectives, and provides a relatively convenient and effective solution for reminding both adults and children to brush their teeth for a minimum of two minutes.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a unique timer or alarm system for timing a brushing session for both children and adults. The system preferably comprises a housing that supports a speaker, a display, a power button, a battery and a two-minute countdown timer. The battery powers the countdown timer, display and speaker. The two-minute countdown timer is activated by switching on the power button, and the display illustrates the amount of time remaining in the brushing session. At the conclusion of the brushing session, the speaker produces a trumpet-style or other audible alert sound to notify the user that the two minutes has elapsed and that the brushing sequence is complete. In a preferred embodiment, the housing is generally octagonal in shape and further comprises an adhesive on its backside to mount the timer system to a bathroom wall or any other desired location where the user is engaged in the brushing or dental care activity. The adhesive may be permanent, such as an acrylic adhesive, or removable, or repositional so that the user may remove and reposition the timing device as needed. The adhesive may be active or activatable, such as with a re-moistenable adhesive. If an active adhesive is used, the pressure sensitive adhesive will be covered by a release liner, which is usually a silicone coated paper.

In a further embodiment of the present invention, a wall or other surface mounted timer device for ensuring effective brushing sessions for children and adults is disclosed. The timer device comprises an octagonal shaped two-minute timer with a front surface and a rear surface. A power button to switch on the timer is positioned on the front surface of the device for convenient access by the user, and a display shows the remaining time left for the brushing session. The display may be an analog or digital display. In addition, the timer device may further include one or more audible sounds to indicate to the user as each second, quarter of a minute, half minute, or full minute is counted off. The rear surface has an adhesive or a hook in order to mount the timer device to a wall or other surface near the brushing station, and the timer device further comprises one or more speakers that produce a trumpet-style or other audible alert sound to notify the user that the two-minute period has elapsed. The audible sound may also be selectable based upon whether the user of the device is a child or adult. For example, for children, the timing device may emit a more whimsical sound, voice of a cartoon or other character, etc. By comparison, for adults, chimes, bells, or other instruments may be used to sound the alert. An internal rechargeable battery is also included to power the various timer components. a wireless communication module for communication with an electronic device and a processor which a user can use to program the countdown timer for different countdown timer value and speaker alert sounds.

In yet another embodiment, the dental care timer may further comprise a wireless transmitter and receiver, such as a Bluetooth transmitter and receiver, so that the timer device can be paired to a smart device, such as a smart phone, tablet, smart watch or the like. In this manner, the user can program the timer device to, for example, set an alarm, play a favorite song or other sound during the brushing session or at the conclusion thereof, etc. Notwithstanding, the wireless technology used to communicate between the timer device and the smart device is not limited to Bluetooth technology, and any other wireless technology may also be used including, without limitation, RFID, NFC and the like.

In a further embodiment of the present invention, a wall or surface mounted teeth brushing session timer apparatus is disclosed. The apparatus provides both visual and audible indications of time progression for the duration of the teeth brushing session and comprises an octagonal or other shaped housing. The housing has an adjustable countdown digital timer disposed therein, wherein the digital timer starts from a pre-programmed timer value every time a power button is switched on by a user. The power button may be activated manually by pressing the power button present on front surface of the timer apparatus, or through a command issued from a wirelessly connected electronic device. The digital timer stops at the expiration of the programmed time amount. The apparatus further comprises a speaker that produces an alert sound when the countdown timer reaches zero to alert the user of the conclusion of the brushing session, and a digital display that illustrates the progression of the countdown timer in bold digits, or in an analog form. A processor is used to program the timer value and the speaker volume, and an internal battery powers the components of the apparatus. Finally, the timer apparatus has an adhesive or a hook on its rear surface for mounting the timer apparatus to a wall or other suitable surface. Alternatively, the timer apparatus may be provided with a stand so that the apparatus can be supported by any flat surface.

In a further embodiment of the present invention, a two minute timer system is disclosed and comprises an octagonal shaped housing having a front surface, a rear surface, a plurality of sides, wherein the housing defines an internal cavity. The cavity has a timing circuit, an internal battery, a wireless communication module, and a processor. The front surface has a digital or analog display, a power button and a speaker. The rear surface has a fastening mechanism, such as an adhesive or hook, for mounting the two minute timer system to a wall or other surface. The timing circuit is connected to both the digital display and the speaker, and is pre-programmed to two minutes, thus displaying two minutes in bold digits “2:00” or in an analog configuration on the display. The timing circuit starts from the programmed value upon pressing of the power button, and the time value continues to count down until it reaches the end of the programmed time period to represent an appropriate brushing session. The display illustrates the progression of the timer throughout the brushing session, and the speaker produces an audible sound to notify the user that the brushing session has concluded. The internal battery provides power to the various components of the two-minute timer system, and the processor controls the connection of the timing circuit to the digital display and the speaker. The wireless communication module is preferably a Wi-Fi/Bluetooth module that allows a remote electronic device to control the two-minute timer system through a wireless connection.

In yet another embodiment of the present invention, a method of providing users with a two-minute alert timer device for a teeth brushing session is disclosed. The method comprises the initial step of turning on the two-minute alert device by actuating a power button present on the front surface of the device. Then, a countdown timer circuit is activated that starts from a programmed time amount, such as two minutes to zero. Next, progression of time decreasing from “2:00” to “0:00” is displayed, and produces an alert sound from a speaker disposed in the device when the countdown timer circuit reaches zero to indicate to the user that the brushing session is complete. Finally, the countdown timer circuit is automatically reset again to two minutes for a new teeth brushing session.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of the dental care timer device of the present invention in accordance with the disclosed architecture, wherein the remaining time is set forth in a digital display;

FIG. 2 illustrates a rear perspective view of one potential embodiment of the dental care timer device of the present invention in accordance with the disclosed architecture, wherein the device comprises an adhesive backing;

FIG. 3 illustrates a diagrammatic representation of the various components of one potential embodiment of the dental care timer device of the present invention in accordance with the disclosed architecture;

FIG. 4 illustrates a front perspective view of one potential embodiment of the dental care timer device of the present invention in accordance with the disclosed architecture, wherein the elapsing of the programmed time in the device causes an audible sound to be emitted through a speaker present on the device; and

FIG. 5 illustrates a front perspective view of one potential embodiment of the dental care timer device of the present invention in accordance with the disclosed architecture, wherein the remaining time is set forth in an analog display and the device further comprises an opening therein for receipt of a toothbrush handle.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a device that enables a user to brush their teeth for at least two minutes, which is the amount of time recommended by various dental associations such as the American Dental Association or ADA, thereby ensuring good oral health of the users. Additionally, there is a long felt need in the art for an alarm device that allows a user to monitor the programmed time as it elapses so that the user can properly allocate and monitor the amount of brushing done in any given area of the mouth (e.g., so that the allotted time may be equally allocated to each region of the user's mouth). Further, there is a long felt need in the art for a two-minute alarm device for brushing teeth that notifies the user when the recommended time for brushing is completed. Finally, there is a long felt need in the art for an alarm device which is safe and easy to use, easily mountable on a wall or other surface, and that is capable of serving the dual purpose of also supporting the user's toothbrush or other oral care products.

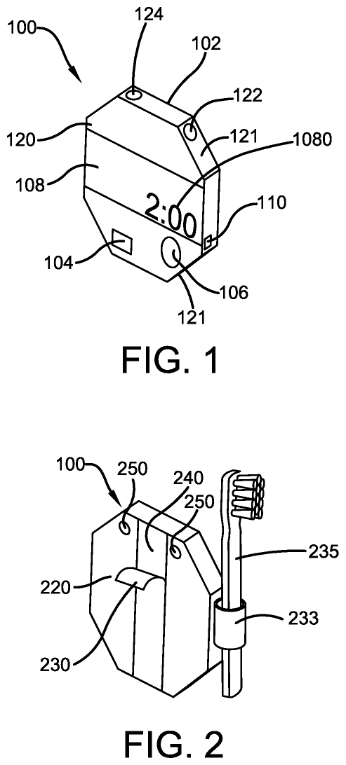

Referring initially to the drawings, FIG. 1 illustrates a front perspective view of one potential embodiment of the dental care timer device 100 of the present invention in accordance with the disclosed architecture, wherein the remaining time is set forth in a digital display 108. More specifically, the dental care timer 100 is comprised of an ornamentally shaped housing 102 having a front face 120, a plurality of sides 121 and a rear surface 220. The front face 120 is further comprised of a digital display 108 that displays the countdown timer 1080 in bold digits. In one embodiment, the digital display 108 may be an LED display and the countdown timer 1080 may have a seven segment display or any other suitable display. In an alternative configuration, an analog display may be used as discussed with respect to later figures.

A power button or switch 104 present at the bottom of the front face 120 is used to turn on a timer circuit (not shown) of the timer device 100 when the power button or switch 104 is actuated by a user. When the timer circuit is turned on by actuation of the power button 104, the display 108 shows the initial programmed timer value 1080 of “2:00” minutes. The digital display 108 then illustrates the progression of time decreasing from “2:00” to “0:00”. A speaker 106 produces an alert sound when the countdown timer circuit reaches zero to indicate to the user that the recommended teeth brushing session is now complete.

A processor is present in the housing 102 of the alert timer device 100 which can be programmed by an individual using a control button or switch 124 present on one of the sides 121 of the housing 102 to a desired initial value of the timer circuit. Further, the timer circuit is connected to both the digital display 108 and the speaker 106. In a preferred embodiment, the dental care timer 100 is comprised of an adjustable countdown digital timer 1080 with a memory, thereby permitting the timer circuit to return from the preset time interval indicated during the start of the cycle down to a “zero” position.

The dental care timer 100 of the present invention is preferably present with a default time period of two minutes as per the guidelines of dental associations for an effective tooth brushing session. The user may press a reset button 122 accessible by the use of a pin, pen head, piece of wire or other narrow element. The reset button 122 is common in many electronic timers and is not discussed further herein.

The dental care timer 100 is preferably powered by one or more single use or rechargeable batteries. Alternatively, the dental care timer 100 may be powered by one of an alternating electrical current or a direct current. If batteries are used as the power source, the batteries should be easily replaceable or removed if necessary. Suitable batteries include alkaline, nickel-cadmium, nickel-metal hydride, etc. Throughout this specification the terms “battery”, “battery pack”, and “batteries” may be used interchangeably to refer to one or more wet or dry cells or batteries of cells in which chemical energy is converted into electricity and used as a source of DC power. References to recharging or replacing batteries may refer to recharging or replacing individual cells, individual batteries of cells, or a package of multiple battery cells as is appropriate for any given battery technology that may be used. Additionally, the digital display 108 may also provide a low battery indicator icon.

FIG. 2 illustrates a rear perspective view of one potential embodiment of the dental care timer device 100 of the present invention in accordance with the disclosed architecture, wherein the device 100 comprises an adhesive backing 240. More specifically, the rear surface 220 of the housing 102 has an adhesive cover 230 thereon, which can be removed to expose the adhesive backing 240 that may be used to mount the device 100 to wood, drywall, metal, painted surfaces or any other similar surface. The adhesive backing 240 provides a safe and strong bond of the device 100 with the wall or other surface. Alternatively, the timer device 100 may comprise cooperating strips of hook and loop fasteners, one or more suction cups, or one or more hooks 250, so that the timer device 100 can be applied to the wall or other surface without the use of an adhesive strip.

In a further embodiment of the present invention, the dental care timer 100 may further comprise a stand to be kept on a horizontal surface at an appropriate location, such as in a washroom, next to a sink, or any other desired place. As best shown in FIG. 2, the timer device 100 may also include a holder or sleeve 233 which can be used to hold a toothbrush 235 or other personal care device, such as a toothpick, water pick attachment or the like. The sleeve or holder 233 may also be used for supporting other items, such as a razor, comb, toothpaste or the like, depending on the size of the sleeve.

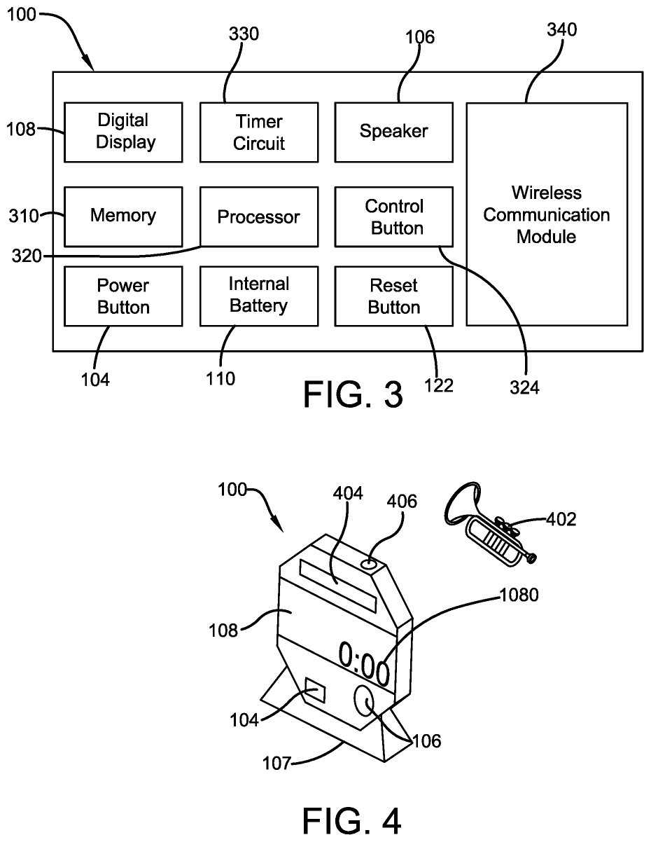

FIG. 3 illustrates a diagrammatic representation of the various components of one potential embodiment of the dental care timer device 100 of the present invention in accordance with the disclosed architecture. More specifically, the dental care device 100 is an electronic timer with a timer circuit 330 that can be controlled by a control button or switch 124. By using the control button or switch 124, the timer circuit 330 can be programmed by a user to a desired timing value other than the default value, which may be pre-set by the manufacturer. The timer circuit 330 can also be reset to the default value, such as two minutes, by a reset button 122. The control of the timer circuit 330 is programmed through the central processor 320 of the device 100. More specifically, a memory 310 stores the instructions to be executed by the processor 320 for the control and resetting of the timer circuit 330. The memory may be used to store a number of different or pre-selected time intervals, ranging from thirty seconds to 1 hour, thereby allowing the device 100 to be multifunctioning and used for other tasks where a timer is required. Further, when the power button 104 is actuated by the user, manually or through a command on an electronic device which is received by the processor 320 through the wireless communication module 340, the timer circuit 330 is reset to the programmed timing value selected by the user. Further, the digital display 108 displays the progression of the countdown timer when the power button 104 is actuated and the speaker 106 emits a sound to notify the user of completion of the selected time interval, or any other timing value programmed in the timer circuit 330.

The timer device 100 of the present invention is advantageous since it is time-adjustable, and provides a constant visual digital countdown of the time remaining for the brushing operation in addition to an audible alert on completion of the time of the brushing session. It is an objective of the dental timer device 100 of the present invention to provide an adjustable timer so that the duration or span of brushing may be adjusted to suit the needs or preferences of the user. Generally, a two-minute brushing session is appropriate for most individuals, and has been recommended by well-known dental associations. However, various other periods may be more appropriate for those with special needs, including those undergoing orthodontic treatment, or those on a home-treatment program for a gum disorder.

In one embodiment, the dental care timer 100 may further comprise multiple different pre-recorded songs, voices, tones or other recordings stored in the memory 310. For example, the display 108 may display a song or tone selector to allow a user to select from a plurality of songs or other sounds that may play during the brushing session or once the alarm sounds. It is also contemplated that the dental care device 100 may play one song or sound during the countdown (i.e., the brushing session), and a second song or sound once the time interval has elapsed (i.e., the brushing session has concluded). The dental timer device 100 may further comprise one or more radios and/or antennas to send and receive wireless signals. For example, the dental timer device 100 may include a Wi-Fi antenna, a cellular antenna, a Bluetooth antenna and/or other type of antenna or mechanism to send and/or receive wireless signals from, for example, a smart device such as a smart phone, smart watch, tablet or the like.

FIG. 4 illustrates a front perspective view of one potential embodiment of the dental care timer device 100 of the present invention in accordance with the disclosed architecture, wherein the elapsing of the programmed time in the device 100 causes an audible sound 402 to be emitted through a speaker 106 present on the device 100. More specifically, once the digital display 108 shows the countdown timer value at “0:00” or “Zero”, the speaker 106 emits a trumpet alarm sound 402 to notify the user who is in a brushing session that the desired time is complete. FIG. 4 also illustrates a retractable stand 107 that may be used to support the dental care device 100, for example, on a table, counter top, or other generally horizontal surface.

The dental care timer device 100 of the present invention encourages healthy brushing habits with a pre-determined interval for brushing. Further, the dental care timer device 100 can be used by children, adolescents, and adults to brush their teeth for appropriate minimum lengths of time, in order to provide for better dental hygiene. The dental care timer device 100 may also be made available in different sizes, shapes and colors to accommodate user need and/or preference, and the exact size, measurement, construction and design specifications of the unique dental timer device 100 of the present invention may vary upon manufacturing or the particular material that is used. The surface of the dental care timer device 100 is preferably flat, but may optionally be concave or convex. The dental care timer device 100 may further comprise logos, indicia, trademarks, geometric patterns, customizable colors and fonts, embroidery and prints and/or images on its surfaces. In one embodiment, the dental care timer device 100 may have a repositionable tray 404 to keep dental cleaning devices, such as a toothbrush, toothpaste etc., and/or a light 406 that is powered by the battery 110, as best shown in FIG. 4.

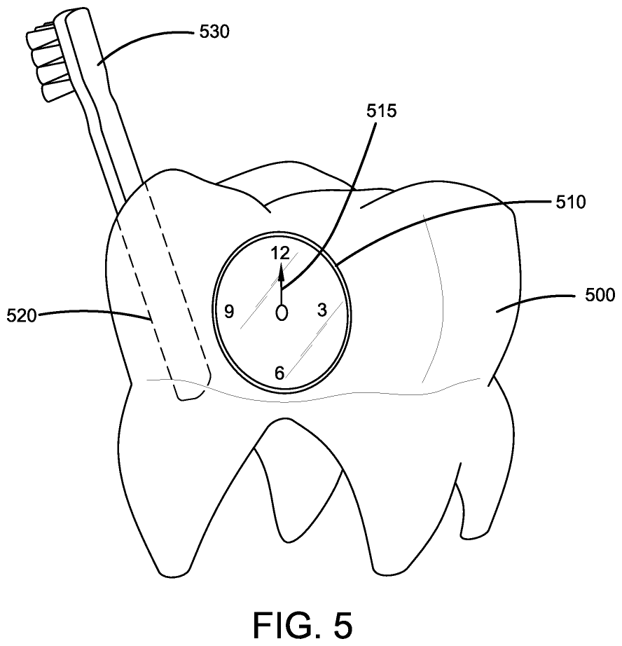

FIG. 5 illustrates a front perspective view of one potential embodiment of the dental care timer device 500 of the present invention in accordance with the disclosed architecture, wherein the remaining time is set forth in an analog display and the device further comprises an opening therein for receipt of a toothbrush handle 530. More specifically, the dental care timer device 500 may be provided in a more whimsical shape, such as the shape of a molar. In this particular embodiment of the present invention, the dental care timer device 500 comprises an analog display 510 including a sweep hand 515 which shows the progress of the countdown. The dental care timer may further comprise a holder 520 into which a dental care device, such as a toothbrush 530, may be inserted and stored until needed.

In another embodiment of the present invention, a method of providing users with a two-minute alert timer device 100, 500 for a teeth brushing session is disclosed. The method comprises the steps of turning on the two-minute alert system by actuating a power button present on a front surface of the two-minute alert timer device, activating a countdown timer circuit that begins at a pre-programmed time (e.g., two minutes), digitally displaying a progression of time decreasing from “2:00” to “0:00”, producing an alert sound from a speaker disposed in the two-minute alert timer device when the countdown timer circuit reaches zero to indicate to the user that the teeth brushing session is complete, and automatically resetting the countdown timer circuit again to two minutes for a new teeth brushing session.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “two-minute alert timer device”, “wall mounted teeth brushing session timer apparatus”, “teeth brushing session timer apparatus”, “timer device”, and “the device” are interchangeable and refer to the two-minute alert timer device 100 of the present invention.

Notwithstanding the forgoing, the dental care timer device 100, 500 of the present invention and its various components can be of any suitable size and configuration as is known in the art without affecting the overall concept of the invention, provided that the same accomplishes the above stated objectives. One of ordinary skill in the art will appreciate that the size, configuration and material of the dental care timer device 100, 500 as shown in the FIGS. are for illustrative purposes only, and that many other sizes and shapes of the dental care timer device 100, 500 are well within the scope of the present disclosure. Although the dimensions of the dental care timer device 100, 500 and its various components are important design parameters for user convenience, the same may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A dental care device comprising:
a timer for providing an alarm after a time recommended by a dental agency has elapsed;
a shaped housing for holding the timer;
a speaker for emitting the alarm; and
a display for showing a remaining time on the timer.

2. The dental care device as recited in claim 1, wherein the dental agency is the American Dental Association.

3. The dental care device as recited in claim 1, wherein the display is one of a digital display or an analog display.

4. The dental care device as recited in claim 3, wherein the analog display comprises a sweeping hand.

5. The dental care device as recited in claim 1, wherein the timer comprises a memory having a plurality of different time intervals stored therein.

6. The dental care device as recited in claim 5, wherein the plurality of different time intervals range from thirty seconds to one hour.

7. The dental care device as recited in claim 1, wherein the time recommended by the dental agency is two minutes.

8. The dental care device as recited in claim 5, wherein the memory comprises a plurality of pre-recorded songs, voices, tones, and sounds.

9. The dental care device as recited in claim 1 further comprising a sleeve to hold a dental care device.

10. The dental care device as recited in claim 9, wherein the dental care device is a toothbrush.

11. The dental care device as recited in claim 1 further comprising a repositionable drawer and a light.

12. The dental care device as recited in claim 1 further comprising a mounting structure, wherein the mounting structure is one of an adhesive attachment, a hook and loop attachment, a hook or a stand.

13. A timer device for facilitating dental care comprising:
a housing comprising a front surface having a display and a rear surface having a mounting structure;
a memory positioned within the housing, wherein the memory comprises a plurality of different time intervals;
a battery;
a processor;
a wireless communication module; and
a speaker that emits an audible sound to signal an end to a selected one of the plurality of different time intervals.

14. The timer device as recited in claim 13, wherein the display is one of an analog display or a digital display.

15. The timer device as recited in claim 13, wherein the mounting structure is one of an adhesive, a hook and loop fastener, a hooks or a stand.

16. The timer device as recited in claim 15, wherein the adhesive is selected from a group including a permanent adhesive, a removable adhesive, and a repositional adhesive.

17. The timer device as recited in claim 15, wherein the adhesive may be an active adhesive or an activatable adhesive.

18. The timer device as recited in claim 13, wherein the wireless communication module is in wireless communication with a smart device.

19. A toothbrushing countdown clock comprising:
an octagonal shaped housing comprised of a front face and a rear face, wherein the front face comprises a digital display, a speaker and a repositionable drawer;
an adhesive mounting strip positioned on the rear face, wherein the adhesive mounting strip is covered by a removable release liner;
a memory contained within the octagonal shaped housing, wherein the memory comprises a plurality of different time intervals and a plurality of pre-recorded sounds, songs, alarms, tones, and voices;
a speaker for emitting a select one of the plurality of pre-recorded sounds, songs, alarms, tones, and voices at the conclusion of a select one of the plurality of different time intervals; and
a wireless communication module for enabling the toothbrushing countdown clock to communicate with a smart device.

20. The toothbrushing countdown clock as recited in claim 19 further comprising a button to activate the digital display and initiate the select one of the plurality of different time intervals.
